(19) United States
(12) Patent Application Publication
(10) Pub. No.: US 2026/0072680 A1
(43) Pub. Date: Mar. 12, 2026

(54) VIRTUAL ASSET MANAGEMENT

(71) Applicant: Beijing Zitiao Network Technology Co., Ltd., Beijing (CN)

(72) Inventors: Wenjing Tang, Beijing (CN); Kun Lin, Beijing (CN); Hanyao Shao, Beijing (CN); Weichen Wang, Beijing (CN); Tianyang Wang, Beijing (CN); Chaoying Cai, Beijing (CN)

(21) Appl. No.: 19/318,690

(22) Filed: Sep. 4, 2025

(30) Foreign Application Priority Data
Sep. 6, 2024 (CN) 202411252641.6

(51) Int. Cl. G06F 8/71; G06F 9/445

(52) U.S. Cl. CPC G06F 8/71; G06F 9/44526

(57) ABSTRACT

A method, an apparatus, a device and a storage medium for virtual asset management are provided. The method includes: presenting an asset management interface of a development space associated with a set of workflows; determining a set of virtual assets associated with the set of workflows, the set of virtual assets including at least one model and/or at least one plug-in associated with the set of workflows; presenting, in the asset management interface, a first set of information items corresponding to the set of virtual assets, wherein the information item indicates at least an obtainance state of a corresponding virtual asset; and performing, in response to receiving a first preset operation for a first information item in the first set of information items, a management action for a target virtual asset corresponding to the first information item, to adjust the obtainance state of the target virtual asset.

### CROSS-REFERENCE

The present application claims priority to Chinese Patent Application No. 202411252641.6, filed on Sep. 6, 2024, and entitled “METHOD, APPARATUS, DEVICE AND STORAGE MEDIUM FOR VIRTUAL ASSET MANAGEMENT”, which is incorporated herein by reference in its entirety.

### FIELD

Example embodiments of the present disclosure generally relate to the field of computer, and in particular, to virtual asset management.

### BACKGROUND

With the rapid development of generative artificial intelligence technology, people can customize various workflows to realize automation of various processes or procedures. However, development of workflows typically relies on various virtual assets, e.g., different models and plug-ins, etc. As workflows become increasingly complex, efficient management for virtual assets becomes an important ring to improve workflow development efficiency.

### SUMMARY

In a first aspect of the present disclosure, a method for virtual asset management is provided. The method includes: presenting an asset management interface of a development space associated with a set of workflows; determining a set of virtual assets associated with the set of workflows, the set of virtual assets including at least one model and/or at least one plug-in associated with the set of workflows; presenting, in the asset management interface, a first set of information items corresponding to the set of virtual assets, wherein an information item in the first set of information items indicates at least an obtainance state of a corresponding virtual asset; and performing, in response to receiving a first preset operation for a first information item in the first set of information items, a management action for a target virtual asset corresponding to the first information item, to adjust the obtainance state of the target virtual asset.

In a second aspect of the present disclosure, an apparatus for virtual asset management is provided. The apparatus includes: an interface presentation module configured to present an asset management interface of a development space associated with a set of workflows; an asset determination module configured to determine a set of virtual assets associated with the set of workflows, the set of virtual assets including at least one model and/or at least one plug-in associated with the set of workflows; an information presentation module configured to present, in the asset management interface, a first set of information items corresponding to the set of virtual assets, wherein an information item in the first set of information items indicates at least an obtainance state of a corresponding virtual asset; and an action execution module configured to perform, in response to receiving a first preset operation for a first information item in the first set of information items, a management action for a target virtual asset corresponding to the first information item, to adjust the obtainance state of the target virtual asset.

In a third aspect of the present disclosure, an electronic device is provided. The device includes at least one processor; and at least one memory coupled to the at least one processor and storing instructions for execution by the at least one processor. The instructions, when executed by the at least one processor, cause the device to perform the method of the first aspect.

In a fourth aspect of the present disclosure, a computer-readable storage medium is provided. The computer-readable storage medium has a computer program stored thereon, and the computer program is executable by a processor to implement the method of the first aspect.

It should be understood that the content described in this summary section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure can be implemented;

FIG. 2A to FIG. 2H illustrate schematic diagrams of interfaces according to some embodiments of the present disclosure;

FIG. 3 illustrates a flowchart of a process for virtual asset management according to some embodiments of the present disclosure;

FIG. 4 illustrates a schematic structural block diagram of an apparatus for virtual asset management according to some embodiments of the present disclosure;

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

It should be noted that the title of any section/subsection provided herein is not limiting. Various embodiments are described throughout and any type of embodiments may be included in any section/subsection. Furthermore, embodiments described in any section/subsection may be combined in any manner with the same section/subsection and/or any other embodiment described in different sections/subsections.

In the description of embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, obtainance and/or use of data, and the like. These aspects all follow the corresponding laws and regulations and related regulations. In embodiments of the present disclosure, all the collection, obtainance, processing, management, forwarding and use of data are carried out on the premise that the user is aware of and confirms it. Accordingly, when implementing the embodiments of the present disclosure, the types of the data or information that may be involved, the usage scope, the usage scenario, and the like should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, processing may be performed on the premise of having a legality basis (for example, obtaining consent of a personal information subject, or necessary for performing a fulfillment contract), and processing only within a specified or agreed range. The user rejects personal information other than necessary information required by the basic function, and does not affect the basic function of the user.

As discussed above, the development of a workflow typically relies on various virtual assets, e.g., different models and plug-ins, etc. In traditional solutions, a user usually lacks awareness of assets related to the workflow, so that some models or plug-ins may be lacked in the development process of the workflow, thereby affecting the development efficiency of the workflow.

Embodiments of the present disclosure provide a solution for virtual asset management. According to this solution, an asset management interface of a development space associated with a set of workflows may be presented. Further, a set of virtual assets associated with the set of workflows may be determined, and the set of virtual assets includes at least one model and/or at least one plug-in associated with the set of workflows.

In addition, a first set of information items corresponding to the set of virtual assets may be presented in the asset management interface, where an information item in the first set of information items indicates at least an obtainance state of a corresponding virtual asset. Further, in response to receiving a first preset operation for a first information item in the first set of information items, a management action for a target virtual asset corresponding to the first information item may be performed to adjust the obtainance state of the target virtual asset.

In this way, embodiments of the present disclosure may provide an asset management interface of a development space to unify management of virtual assets (e.g., models and plug-ins) related to the workflows in a workspace, thereby improving efficiency for virtual asset management.

### Example Environment

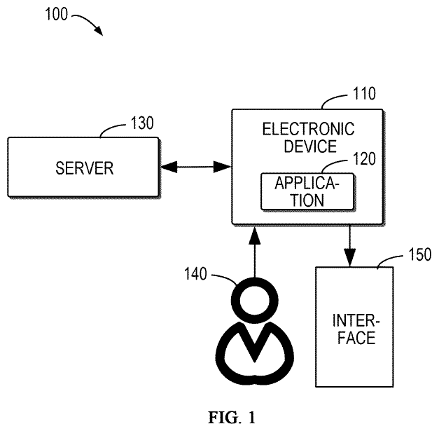

FIG. 1 illustrates a schematic diagram of an example environment 100 in which embodiments of the present disclosure can be implemented. As shown in FIG. 1, the example environment 100 may include an electronic device 110.

In the example environment 100, an application 120 is installed in the electronic device 110. A user 140 may interact with the application 120 via the electronic device 110 and/or its attachment device. The application 120 may be an application for editing a workflow, etc., or any other suitable application. For example, the application 120 may be a browser and provide services for virtual asset management by accessing a website.

In the environment 100 of FIG. 1, if the application 120 is active, the application 120 may provide a display interface 150 for the user 140. The user 140 may perform operations for virtual asset management based on the interface 150.

In some embodiments, the electronic device 110 communicates with the server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, etc.).

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for applications 120 that support content display in the electronic device 110.

A communication connection may be established between the server 130 and the electronic device 110. The communication connection may be established in a wired manner or a wireless manner. The communication connection may include, but are not limited to, Bluetooth connection, mobile network connection, universal serial bus connection, wireless fidelity connection, etc., embodiments of the present disclosure are not limited in this respect. In embodiments of the present disclosure, the server 130 and the electronic device 110 may implement signaling interaction through the communication connection between the server 130 and the electronic device 110.

It should be understood that the structures and functions of the various elements in the environment 100 are described for illustrative purposes only and do not imply any limitation to the scope of the present disclosure.

Some example embodiments of the present disclosure will be described below with continued reference to the accompanying drawings.

### Example Interaction

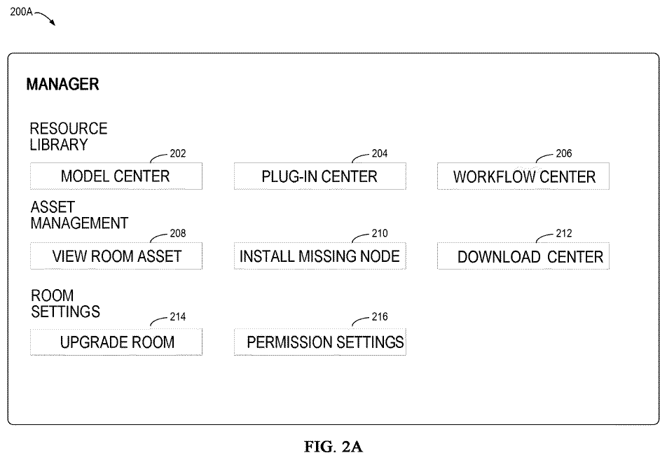

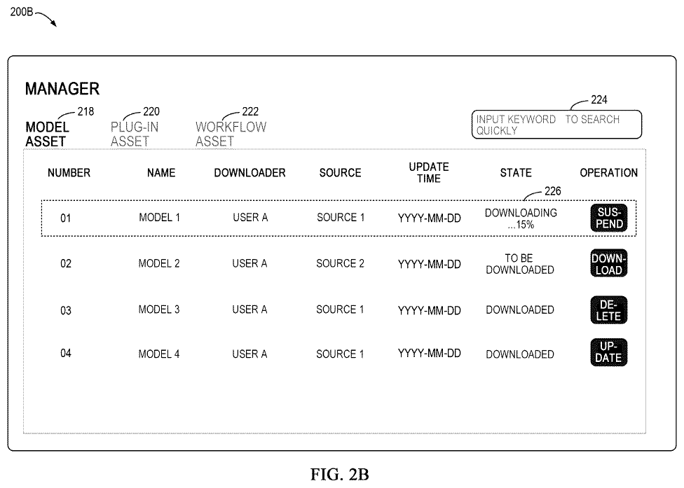

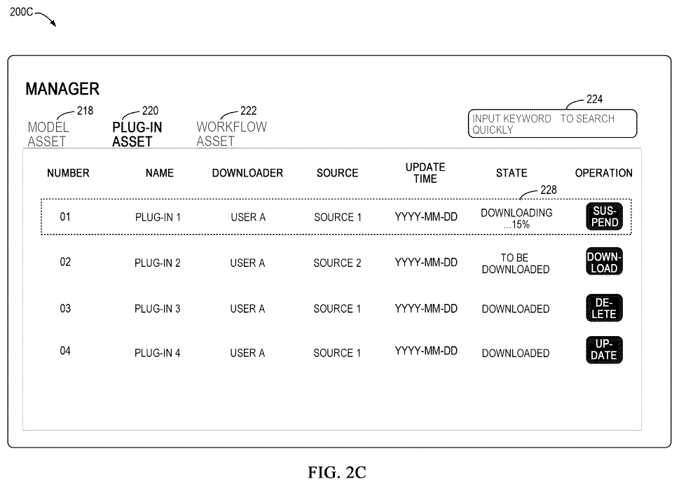

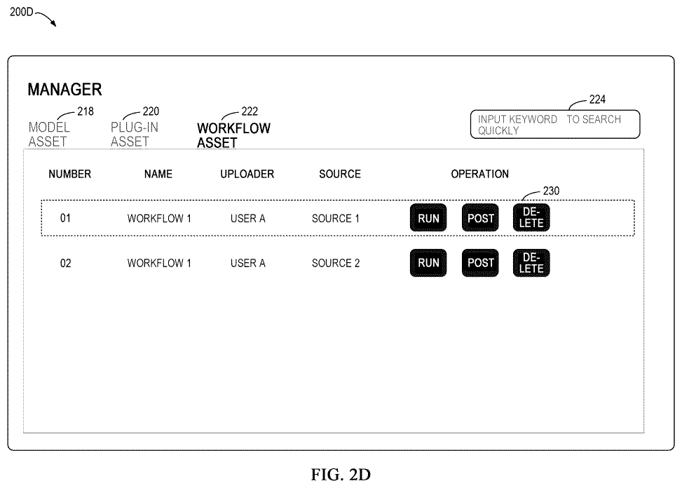

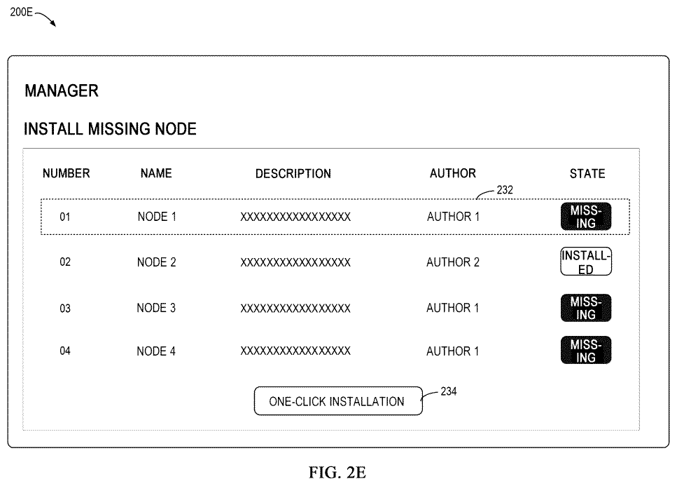

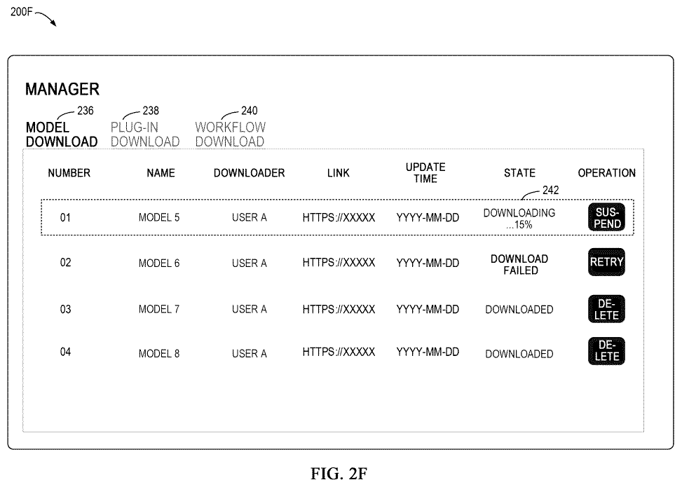

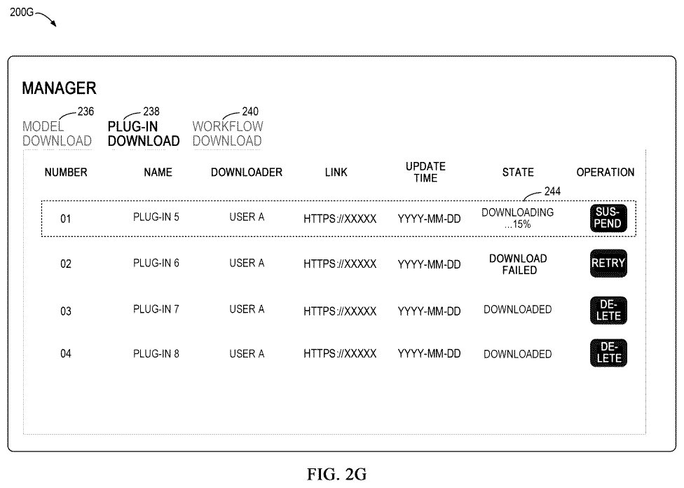

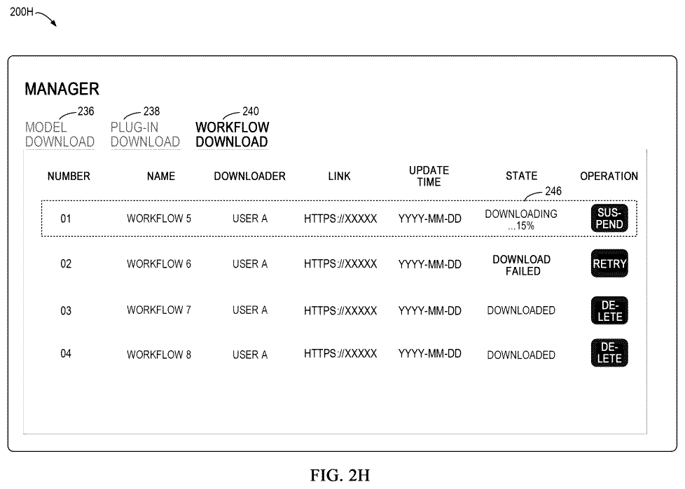

Example interfaces described below with reference to FIG. 2A to FIG. 2H. FIG. 2A to FIG. 2H illustrate example interfaces 200A to 200H, which may be provided by the electronic device 110 shown in FIG. 1, for example, in accordance with some embodiments of the present disclosure.

As shown in FIG. 2A, the electronic device 110 may present a management interface 200A of a development space. In some embodiments, the development space may also be referred to as a room, which may be associated with one or more developers to support a user creating or editing the corresponding one or more workflows in the development space.

In some embodiments, such a workflow may include a plurality of nodes, and each node, for example, may be associated with a corresponding model or plug-in to support a corresponding processing task.

In some embodiments, as shown in FIG. 2A, the electronic device 110 may provide a plurality of management entries in the management interface 200A. As an example, the electronic device 110 may provide an entry 202, an entry 204, and an entry 206 associated with asset obtainance.

As an example, the entry 202 may be used to trigger, for example, to display a tab corresponding to a model center, so that the user may add a model asset posted in a platform to the development space.

As another example, the entry 202 may be used to trigger, for example, to display a tab corresponding to a plug-in center, so that the user may add a plug-in asset posted in the platform to the development space.

As another example, the entry 202 may be used to trigger, for example, to display a tab corresponding to a workflow center, so that the user may add a workflow template posted in the platform to the development space.

In some embodiments, the electronic device 110 may also provide a plurality of entries associated with asset management of the development space, such as an entry 208, an entry 210, and an entry 212.

In some embodiments, the electronic device 110 may receive a selection of the entry 208 and present an asset management interface 200B as shown in FIG. 2B. As shown in FIG. 2B, the asset management interface 200B may, for example, be used to display information of a set of virtual assets associated with the development space. In the present disclosure, the virtual asset may represent an intangible asset added or created by the development space, or may be referred to as a digital asset. As an example, such a set of virtual assets may include model assets, plug-in assets, or workflow assets.

The electronic device 110 may determine a set of virtual assets associated with at least one workflow of the development space, such as a model and/or a plug-in or the like on which the workflow relies, and may display information corresponding to the virtual asset in the asset management interface 200B.

As shown in FIG. 2B, different virtual assets may correspond to different tabs. For example, the model asset may correspond to a tab bar 218, and FIG. 2B shows its corresponding tab. The plug-in asset may correspond to a tab bar 220, and FIG. 2C shows its corresponding tab. The workflow asset may correspond to a tab bar 222, and FIG. 2D shows its corresponding tab.

Specific information displayed by each tab will be further described below. As shown in FIG. 2B, the electronic device 110 may display, in a tab corresponding to the model asset, at least one information item, for example, an information item 226, corresponding to at least one model associated with the development space. Such at least one model may represent one or more models that one or more workflows in the development space rely on.

As shown in FIG. 2B, the information item 226 may show information of various aspects of the model, such as a name of the model, a downloader of the model, a source of the model, a date of update of the model, an obtainance state of the model, and the like.

In some embodiments, the obtainance state annotated by the information item 226 may indicate whether the corresponding model has been downloaded. As an example, such an obtainance state may include “to be downloaded,” “downloaded,” and “downloading. ” In some embodiments, for the “downloading” model, the information item 226 may also specifically indicate the download progress of the model.

In some embodiments, the electronic device 110 may also provide one or more operation entries in the information item for managing the corresponding model. Taking the information item 226 as an example, the electronic device 110 may suspend downloading the corresponding model based on selection of the “suspend”button.

In some embodiments, for example, the operation entry may further include a download entry for triggering to download the corresponding model, a stop entry for triggering to stop downloading the corresponding model, a deletion entry for triggering to delete the corresponding model, an update entry for triggering to update the corresponding model, and the like.

The electronic device 110 may change the obtainance state of the corresponding model based on the selection of these operation entries.

As another example, the electronic device 110 may receive a selection of the tab bar 220 and display a tab corresponding to the plug-in asset in FIG. 2C.

Similar to that introduced in FIG. 2B, the electronic device 110 may display at least one information item, for example, an information item 228, corresponding to at least one plug-in associated with the development space in the tab corresponding to the plug-in asset. Such at least one plug-in may represent one or more plug-ins that one or more workflows in the development space rely on.

Similarly, the electronic device 110 may trigger to suspend downloading a corresponding plug-in, trigger to download a corresponding plug-in, trigger to stop downloading a corresponding plug-in, trigger to delete a corresponding plug-in, or trigger to update a corresponding plug-in, and the like, based on a selection of an operation entry included in the information item 228.

As another example, the electronic device 110 may receive a selection of the tab bar 222 and display a tab corresponding to the workflow asset in FIG. 2D.

Similar to that introduced in FIG. 2B, the electronic device 110 may display, in a tab corresponding to the workflow asset, a set of information items, for example, an information item 230, corresponding to at least one workflow associated with the development space. Such at least one workflow may represent one or more workflows added in the development space.

In some embodiments, the electronic device 110 may trigger to use a corresponding workflow, trigger to post a corresponding workflow, or trigger to delete a corresponding workflow, and the like, based on a selection of an operation entry included in the information item 230.

Additionally, as shown in FIG. 2B to FIG. 2D, the electronic device 110 may also provide a search control 224 to support a user searching for the virtual asset quickly by name or other keywords.

With continued reference to FIG. 2A, the electronic device 110 may also receive a selection of the entry 210 and present a node management interface 200E as shown in FIG. 2E. As shown in FIG. 2E, the electronic device 110 may present, in the node management interface 200E, an installation state of a plurality of nodes associated with a set of workflows in the development space.

As shown in FIG. 2E, an information item 232 may indicate that “node 1” is not currently installed. As an example, the electronic device 110 may receive a selection of a “missing” label and trigger to install the missing “node 1”in a development space 1.

With continued reference to FIG. 2A, the electronic device 110 may also receive a selection of the entry 212 and present an asset download interface 200F as shown in FIG. 2F. As shown in FIG. 2F, the electronic device 110 may present, in the asset download interface 200F, a set of information items corresponding to a set of historical download requests to display a processing state corresponding to the set of historical download requests.

As shown in FIG. 2F to FIG. 2H, the asset management interface 200F may include a plurality of tabs, such as a tab for managing model downloads, a tab for managing plug-in downloads, and a tab for managing workflow downloads.

Specifically, as shown in FIG. 2F, an information item 242 may indicate a processing state of a historical download request for downloading a model, for example, “downloading . . . 15%”. The processing state may include “downloading”, “download failed”, and “downloaded”. For the download request with “downloading”, the processing state may also indicate the current download progress.

In some embodiments, the electronic device 110 may also provide an operation entry for managing a corresponding download request. Taking the information item 242 as an example, the electronic device 110 may suspend processing of the corresponding download request based on a selection of the “suspend”button.

In some embodiments, for example, such operation entry may further include a download entry for triggering to download the corresponding model, a stop entry for triggering to stop downloading the corresponding model, and a deletion entry for triggering to delete the corresponding model.

As another example, the electronic device 110 may receive a selection of a tab bar 238 and show a tab corresponding to a plug-in download request in FIG. 2G.

Similar to FIG. 2F, the electronic device 110 may display at least one information item, for example, an information item 244, corresponding to the at least one plug-in download request in the tab corresponding to the plug-in download request. The information item 244 may indicate the processing state of the corresponding plug-in download request.

Similarly, the electronic device 110 may trigger to suspend downloading a corresponding plug-in, trigger to download a corresponding plug-in, trigger to stop downloading a corresponding plug-in, and trigger to delete a corresponding plug-in, based on a selection of an operation entry included in the information item 244.

As yet another example, the electronic device 110 may receive a selection of a tab bar 240 and display a tab corresponding to a workflow download request in FIG. 2H.

Similar to that described in FIG. 2F and FIG. 2G, the electronic device 110 may display a set of information items, for example, an information item 246, corresponding to a set of workflow download requests in the tab corresponding to the workflow download request. The information item 246 may indicate the processing state of the corresponding workflow download request.

Similarly, the electronic device 110 may trigger to suspend downloading the corresponding workflow, trigger to download the corresponding workflow, trigger to stop downloading the corresponding workflow, or trigger to delete the corresponding workflow, based on a selection of the operation entry included in the information item 246.

Based on the processes described above, embodiments of the present disclosure may provide an asset management interface of the development space to unify management of virtual assets (e.g., models and plug-ins) related to the workflow in the workspace, thereby improving efficiency for virtual asset management.

With continued reference to FIG. 2A, the electronic device 110 may also provide an entry for setting a development space, for example, an entry 214 and an entry 216, in the management interface 200A. As an example, the entry 214 may be used to upgrade the development space to extend the number of workflows supported to be created, the functionality allowed to be used, and the like, of the development space. The entry 216 may, for example, manage permissions associated with the development space.

### Example Processes

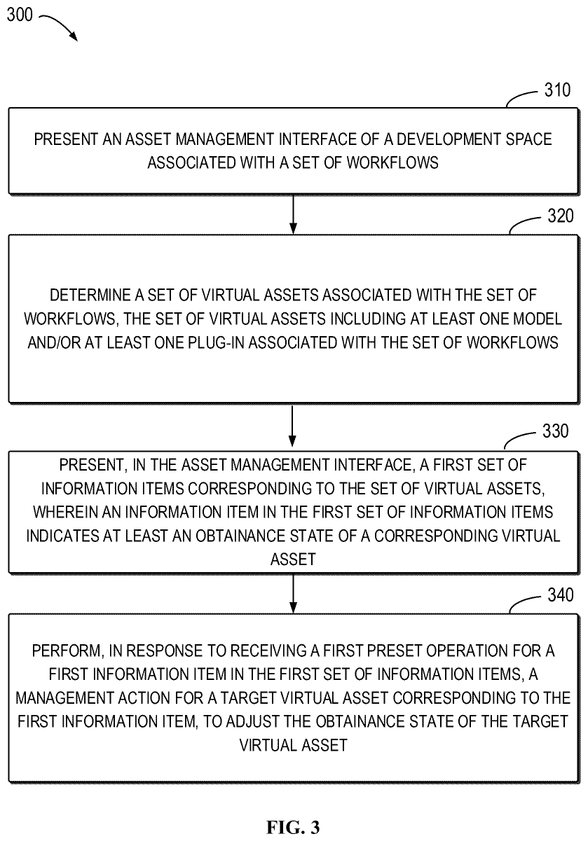

FIG. 3 illustrates a flowchart of a process 300 for virtual asset management according to some embodiments of the present disclosure. The process 300 may be implemented at the electronic device 110. The process 300 is described below with reference to FIG. 1.

At block 310, the electronic device 110 presents an asset management interface of the development space associated with a set of workflows.

At block 320, the electronic device 110 determines a set of virtual assets associated with the set of workflows, the set of virtual assets including at least one model and/or at least one plug-in associated with a set of workflows.

At block 330, the electronic device 110 presents, in the asset management interface, a first set of information items corresponding to the set of virtual assets, wherein an information item in the first set of information items indicates at least an obtainance state of a corresponding virtual asset.

At block 340, the electronic device 110 performs, in response to receiving a first preset operation for a first information item in the first set of information items, a management action for a target virtual asset corresponding to the first information item, to adjust the obtainance state of the target virtual asset.

In some embodiments, performing the management action for the target virtual asset includes one of: downloading the target virtual asset; deleting the target virtual asset; updating the target virtual asset; suspending or stopping downloading the target virtual asset.

In some embodiments, the asset management interface includes: a first tab configured to display the at least one model associated with the set of workflows; and a second tab configured to display the at least one plug-in associated with the set of workflows.

In some embodiments, the asset management interface further includes: a third tab configured to display a second set of information items corresponding to the set of workflows.

In some embodiments, the process 300 further includes: performing, in response to receiving a second preset operation for a second information item in the second set of information items, one of the following: using a corresponding workflow, posting a corresponding workflow, or deleting a corresponding workflow.

In some embodiments, the process 300 further includes: presenting, in response to receiving a first management request, an asset download interface of the development space; and presenting, in the asset download interface, a third set of information items corresponding to a set of historical download requests for downloading a corresponding virtual asset, the third set of information items indicating a processing state of the set of historical download requests.

In some embodiments, the asset download interface includes: a fourth tab configured to display a processing state of a first set of historical download requests for downloading the model; and a fifth tab configured to display a processing state of a second set of historical download requests for downloading the plug-in.

In some embodiments, the asset management interface further includes: a sixth tab configured to display a processing state of a third set of historical download requests for downloading the workflow.

In some embodiments, the process 300 further includes: performing, in response to receiving a third preset operation for a third information item in the third set of information items, one of the following: deleting the downloaded virtual asset, re-downloading the corresponding virtual asset, stopping or suspending downloading the corresponding virtual asset.

In some embodiments, the process 300 further includes: presenting, in response to receiving a second management request, a node management interface of the development space; and presenting, in the node management interface, an installation state of a plurality of nodes associated with the set of workflows.

In some embodiments, the process 300 further includes: installing, via the node management interface, at least one node missing from the development space.

### Example Apparatus and Apparatus

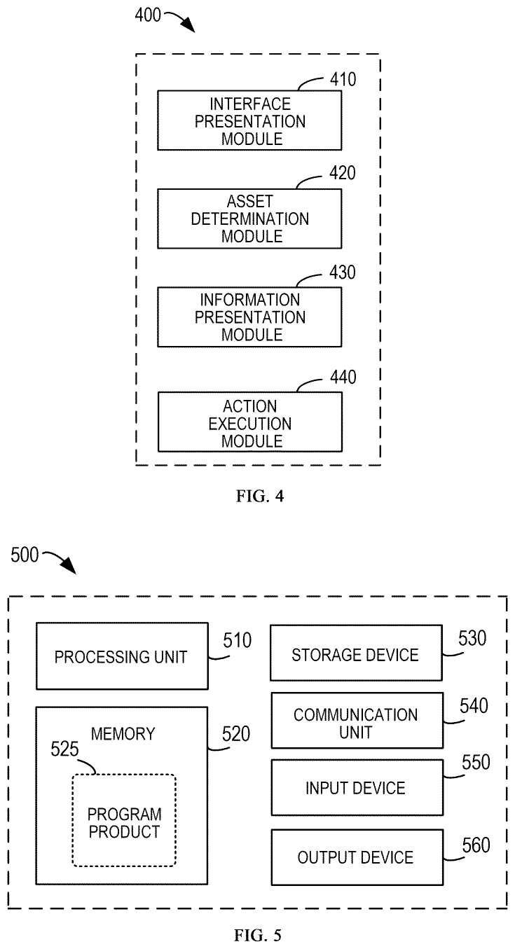

Embodiments of the present disclosure also provide a corresponding apparatus for implementing the above method or process. FIG. 4 shows a schematic structural block diagram of an apparatus 400 for virtual asset management according to some embodiments of the present disclosure. The apparatus 400 may be implemented or included in the electronic device 110 as discussed above. The various modules/components in the apparatus 400 may be implemented by hardware, software, firmware, or any combination thereof.

As shown in FIG. 4, the apparatus 400 includes an interface presentation module 410 configured to present an asset management interface of a development space associated with a set of workflows; an asset determination module 420 configured to determine a set of virtual assets associated with the set of workflows, the set of virtual assets including at least one model and/or at least one plug-in associated with the set of workflows; an information presentation module 430 configured to present, in the asset management interface, a first set of information items corresponding to the set of virtual assets, wherein an information item in the first set of information items indicates at least an obtainance state of a corresponding virtual asset; and an action execution module 440 configured to perform, in response to receiving a first preset operation for a first information item in the first set of information items, a management action for a target virtual asset corresponding to the first information item, to adjust the obtainance state of the target virtual asset.

In some embodiments, performing the management action for the target virtual asset includes one of: downloading the target virtual asset; deleting the target virtual asset; updating the target virtual asset; suspending or stopping downloading the target virtual asset.

In some embodiments, the asset management interface includes a first tab configured to display the at least one model associated with the set of workflows; and a second tab configured to display the at least one plug-in associated with the set of workflows.

In some embodiments, the asset management interface further includes: a third tab configured to display a second set of information items corresponding to the set of workflows.

In some embodiments, the apparatus 400 further includes a first processing module configured to perform, in response to receiving a second preset operation for a second information item in the second set of information items, one of the following: using a corresponding workflow, posting a corresponding workflow, or deleting a corresponding workflow.

In some embodiments, the apparatus 400 further includes a second processing module configured to present, in response to receiving a first management request, an asset download interface of the development space; and present, in the asset download interface, a third set of information items corresponding to a set of historical download requests for downloading a corresponding virtual asset, the third set of information items indicating a processing state of the set of historical download requests.

In some embodiments, the asset download interface includes: a fourth tab configured to display a processing state of a first set of historical download requests for downloading the model; and a fifth tab configured to display a processing state of a second set of historical download requests for downloading the plug-in.

In some embodiments, the asset management interface further includes: a sixth tab configured to display a processing state of a third set of historical download requests for downloading the workflow.

In some embodiments, the apparatus 400 further includes a third processing module configured to perform, in response to receiving a third preset operation for a third information item in the third set of information items, one of the following: deleting the downloaded virtual asset, re-downloading the corresponding virtual asset, stopping or suspending downloading the corresponding virtual asset.

In some embodiments, the apparatus 400 further includes a fourth processing module configured to present, in response to receiving a second management request, a node management interface of the development space; and present, in the node management interface, an installation state of a plurality of nodes associated with the set of workflows.

In some embodiments, the apparatus 400 further includes a fifth processing module configured to install, via the node management interface, at least one node missing from the development space.

The units included in the apparatus 400 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the elements in the apparatus 400 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

FIG. 5 illustrates a block diagram of an electronic device 500 in which one or more embodiments of the present disclosure may be implemented. It should be understood that the electronic device 500 illustrated in FIG. 5 is merely illustrative and should not constitute any limitation on the functionality and scope of the embodiments described herein. The electronic device 500 shown in FIG. 5 may be configured to implement the electronic device 110 shown in FIG. 1.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, multiple processing units execute computer-executable instructions in parallel to improve parallel processing capabilities of electronic device 500.

Electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 530 may be a removable or non-removable medium and may include a machine-readable medium, such as a flash drive, magnetic disk, or any other medium, which may be capable of storing information and/or data (e.g., training data for training) and may be accessed within electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 is configured to communicate with another electronic device through a communication medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices, such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in one or more blocks in the flowchart(s) and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in one or more blocks in the flowchart(s) and/or block diagram(s).

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagram(s) and/or flowchart(s), may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for virtual asset management, comprising:
presenting an asset management interface of a development space associated with a set of workflows;
determining a set of virtual assets associated with the set of workflows, the set of virtual assets comprising at least one model and/or at least one plug-in associated with the set of workflows;
presenting, in the asset management interface, a first set of information items corresponding to the set of virtual assets, wherein an information item in the first set of information items indicates at least an obtainance state of a corresponding virtual asset; and
performing, in response to receiving a first preset operation for a first information item in the first set of information items, a management action for a target virtual asset corresponding to the first information item, to adjust the obtainance state of the target virtual asset.

2. The method of claim 1, wherein performing the management action for the target virtual asset comprises one of:
downloading the target virtual asset;
deleting the target virtual asset;
updating the target virtual asset;
suspending or stopping downloading the target virtual asset.

3. The method of claim 1, wherein the asset management interface comprises:
a first tab configured to display the at least one model associated with the set of workflows; and
a second tab configured to display the at least one plug-in associated with the set of workflows.

4. The method of claim 3, wherein the asset management interface further comprises:
a third tab configured to display a second set of information items corresponding to the set of workflows.

5. The method of claim 4, further comprising:
performing, in response to receiving a second preset operation for a second information item in the second set of information items, one of the following: using a corresponding workflow, posting a corresponding workflow, or deleting a corresponding workflow.

6. The method of claim 1, further comprising:
presenting, in response to receiving a first management request, an asset download interface of the development space; and
presenting, in the asset download interface, a third set of information items corresponding to a set of historical download requests for downloading a corresponding virtual asset, the third set of information items indicating a processing state of the set of historical download requests.

7. The method of claim 6, wherein the asset download interface comprises:
a fourth tab configured to display a processing state of a first set of historical download requests for downloading the model; and
a fifth tab configured to display a processing state of a second set of historical download requests for downloading the plug-in.

8. The method of claim 7, wherein the asset management interface further comprises:
a sixth tab configured to display a processing state of a third set of historical download requests for downloading the workflow.

9. The method of claim 6, further comprising:
performing, in response to receiving a third preset operation for a third information item in the third set of information items, one of the following: deleting the downloaded virtual asset, re-downloading the corresponding virtual asset, stopping or suspending downloading the corresponding virtual asset.

10. The method of claim 1, further comprising:
presenting, in response to receiving a second management request, a node management interface of the development space; and
presenting, in the node management interface, an installation state of a plurality of nodes associated with the set of workflows.

11. The method of claim 10, further comprising:
installing, via the node management interface, at least one node missing from the development space.

12. An electronic device comprising:
at least one processor; and
at least one memory coupled to the at least one processor and storing instructions for execution by the at least one processor, the instructions, when executed by the at least one processor, causing the electronic device to perform acts comprising:
presenting an asset management interface of a development space associated with a set of workflows;
determining a set of virtual assets associated with the set of workflows, the set of virtual assets comprising at least one model and/or at least one plug-in associated with the set of workflows;
presenting, in the asset management interface, a first set of information items corresponding to the set of virtual assets, wherein an information item in the first set of information items indicates at least an obtainance state of a corresponding virtual asset; and
performing, in response to receiving a first preset operation for a first information item in the first set of information items, a management action for a target virtual asset corresponding to the first information item, to adjust the obtainance state of the target virtual asset.

13. The electronic device of claim 12, wherein performing the management action for the target virtual asset comprises one of:
downloading the target virtual asset;
deleting the target virtual asset;
updating the target virtual asset;
suspending or stopping downloading the target virtual asset.

14. The electronic device of claim 12, wherein the asset management interface comprises:
a first tab configured to display the at least one model associated with the set of workflows; and
a second tab configured to display the at least one plug-in associated with the set of workflows.

15. The electronic device of claim 14, wherein the asset management interface further comprises:
a third tab configured to display a second set of information items corresponding to the set of workflows.

16. The electronic device of claim 15, wherein the acts further comprise:
performing, in response to receiving a second preset operation for a second information item in the second set of information items, one of the following: using a corresponding workflow, posting a corresponding workflow, or deleting a corresponding workflow.

17. The electronic device of claim 12, wherein the acts further comprise:
presenting, in response to receiving a first management request, an asset download interface of the development space; and
presenting, in the asset download interface, a third set of information items corresponding to a set of historical download requests for downloading a corresponding virtual asset, the third set of information items indicating a processing state of the set of historical download requests.

18. The electronic device of claim 17, wherein the asset download interface comprises:
a fourth tab configured to display a processing state of a first set of historical download requests for downloading the model; and
a fifth tab configured to display a processing state of a second set of historical download requests for downloading the plug-in.

19. The electronic device of claim 18, wherein the asset management interface further comprises:
a sixth tab configured to display a processing state of a third set of historical download requests for downloading the workflow.

20. A non-transitory computer-readable storage medium having a computer program stored thereon, the computer program, when executed by a processor, implementing acts comprising:
presenting an asset management interface of a development space associated with a set of workflows;
determining a set of virtual assets associated with the set of workflows, the set of virtual assets comprising at least one model and/or at least one plug-in associated with the set of workflows;
presenting, in the asset management interface, a first set of information items corresponding to the set of virtual assets, wherein an information item in the first set of information items indicates at least an obtainance state of a corresponding virtual asset; and
performing, in response to receiving a first preset operation for a first information item in the first set of information items, a management action for a target virtual asset corresponding to the first information item, to adjust the obtainance state of the target virtual asset.
